(19) United States
(12) Patent Application Publication
(10) Pub. No.: US 2025/0000243 A1
(43) Pub. Date: Jan. 2, 2025

(54) ATHLETIC EQUIPMENT BAG INCLUDING A CLOSURE SYSTEM

(71) Applicant: Nike, Inc., Beaverton, OR (US)

(72) Inventor: Brent RADEWALD, Portland, OR (US)

(73) Assignee: Nike, Inc., Beaverton, OR (US)

(21) Appl. No.: 18/663,944

(22) Filed: May 14, 2024

Related U.S. Application Data
(60) Provisional application No. 63/510,564, filed on Jun. 27, 2023.

(51) Int. Cl. A45F 3/04

(52) U.S. Cl. CPC A45F 3/04

(57) ABSTRACT

A bag having a back panel extending from a bottom end toward a top end. The back panel having a plurality of loops disposed along the top end and the bottom end; at least one detachable strap; and at least two fasteners. Each of the at least two fasteners are attachable to the at least one detachable strap. Each fastener is able to be detachably coupled to the back panel via at least one of the plurality of loops.

### CROSS-REFERENCE TO RELATED APPLICATION

This application claims priority under 35 U.S.C. § 119(e) to Provisional U.S. Patent Application No. 63/510,564, filed Jun. 27, 2023, the disclosure of which is hereby incorporated by reference in its entirety.

### FIELD

The present invention relates in general to portable storage bags, and more particularly, to bags including a closure system that facilitates ease of access by users with limited dexterity.

### BACKGROUND

This section provides background information related to the present disclosure which is not necessarily prior art.

Athletic equipment bags are becoming increasingly popular among athletes in numerous sports because of their portability, functionality in storing various items, and aesthetic designs. Known athletic equipment bags are lightweight and flexible to provide easier transport of the athlete's equipment, clothing, and other gear. Athletic equipment bags typically include multiple compartments for storing different items, with each compartment accessible via one or more closure systems that typically include zippers, pull-tabs, handles, and more. These closure systems often require two hands to operate and/or are generally difficult to operate without full dexterity. Additionally, athletic equipment bags often include straps that are sewn at both ends of the bag such that if one or more of the straps were to be damaged, a user would need to replace the entire bag.

### BRIEF DESCRIPTION OF THE DRAWINGS

The detailed description of the invention will be described in relation to the accompanying drawings. In the drawings, the following figures have the following general nature:

FIG. 1A is a front view of an athletic equipment bag;

FIG. 1B is a front perspective view of the athletic equipment bag of FIG. 1A;

FIG. 2 is a left side view of the athletic equipment bag of FIG. 1A;

FIG. 3 is a right side view of the athletic equipment bag of FIG. 1A;

FIG. 4 is a rear perspective view of the athletic equipment bag of FIG. 1A;

FIG. 5 is a partial rear view of the athletic equipment bag of FIG. 1A in a first configuration;

FIG. 6 is a partial rear view of the athletic equipment bag of FIG. 1A in a second configuration;

FIG. 7A is a partial rear view of the athletic equipment bag of FIG. 1A in a third configuration;

FIG. 7B is a partial side view of the athletic equipment bag of FIG. 1A;

FIG. 8 is a partial rear view of an opening of a panel of the athletic equipment bag of FIG. 1A;

FIG. 9 is a front view of a user opening the athletic equipment bag of FIG. 1A;

FIG. 10A is a front perspective view of the athletic equipment bag of FIG. 1A in a partially opened state;

FIG. 10B is a front perspective view of the athletic equipment bag of FIG. 1A in a partially opened state;

FIG. 10C is a front perspective view of the athletic equipment bag of FIG. 1A in a fully opened state;

FIG. 11 is a front view of the athletic equipment bag of FIG. 1A in a partially opened configuration, with a compartment of the athletic equipment bag accessible to a user;

FIG. 12 is a front view of the athletic equipment bag of FIG. 1A in a partially opened configuration, with a compartment of the athletic equipment bag accessible to a user;

FIG. 13 is a side perspective view of the athletic equipment bag of FIG. 1A in a partially opened configuration, with a compartment of the athletic equipment bag accessible to a user;

FIG. 14 is a partial view of a hook of the athletic equipment bag of FIG. 1A;

FIG. 15A is a perspective view of the hook of FIG. 12;

FIG. 15B is a rear view of the hook of FIG. 12;

FIG. 16 is a rear perspective view of another athletic equipment bag including a single strap; and

FIG. 17 is a rear perspective view of another athletic equipment bag including a pair of straps.

Corresponding reference numerals indicate corresponding parts throughout the several views of the drawings.

### DETAILED DESCRIPTION

The present disclosure overcomes these challenges and other known disadvantages with existing athletic equipment bags by providing a bag with a closure system that allows for users of limited dexterity to access the compartments of the athletic bag, as well as users capable of only utilizing a single hand. Additionally, the present disclosure allows for interchangeability of the straps such that if one or more of the straps were damaged, the user would only need to replace the straps, or the user could swap straps for different purposes.

Example configurations will now be described more fully with reference to the accompanying drawings. Example configurations are provided so that this disclosure will be thorough and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer, or section. Terms such as “first,” “second,” and other numerical terms do not imply a sequence or order unless clearly indicated by the context. Thus, a first element, component, region, layer, or section discussed below could be termed a second element, component, region, layer, or section without departing from the teachings of the example configurations. In the discussion that follows, terms “about,” “approximately,” “substantially,” and the like, when used in describing a numerical value, denote a variation of +/−10% of that value, unless specified otherwise.

When an element or layer includes a directional and/or spatial term (e.g., top, bottom, medial, lateral, etc.), the directional and/or spatial term is used relative to when the athletic equipment bag is upright on a flat, level surface.

The subject matter of embodiments of the present disclosure is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly stated.

Although the description is in reference to an athletic equipment bag, it should be appreciated that such reference is merely exemplary and that the present disclosure is not limited to bags intended for use in storing athletic equipment. Bags include different types of portable storage apparatuses, such as, but not limited to, purses, backpacks, satchels, carriers, and the like. The technology disclosed herein may equally be used to create various types of bags. To alleviate confusion and to provide a more readable disclosure, embodiments simply reference bags. To that end and to provide a robust disclosure, different components or portions of bags are discussed herein, including zippers, panels, and compartments.

Aspects hereof provide a bag that includes a main storage compartment that is accessible by opening one or more panels. One or more of the panels are releasably fastened to adjacent panels by way of a closure system, such as a zipper or other releasable fastener (e.g., hook-and-loop strips, snaps, buttons, hooks, and the like). The bag might also include one or more accessory storage compartments constructed into the one or more panels or into a back panel of the bag.

The main storage compartment generally includes a storage space that may be larger than the accessory storage compartments and might include one or more additional storage pockets accessible from inside or outside the storage space. The accessory storage compartments are generally separated from the storage space of the main storage compartment and might be used to stow various items, such as athletic balls, footwear, towels, uniforms, sports drinks, sports supplements, and the like. The terms “storage” and “stowage” might be used interchangeably in this description, as well as the terms “storage area,” “compartment,” and “storage space.” In addition, “accessory storage compartments” may also be referred to herein as “accessory compartments,” “accessory pockets,” “storage pockets,” or just “pockets”.

In a further aspect, the bag may be wearable as a backpack. For instance, the bag might include one or more straps that can be worn on one or both shoulders of a user. A normal manner of wear for the bag, when configured as a backpack, is for the user to place one or both arms through the one or more straps such that a panel of the backpack contacts the user's back. In one aspect, the backpack is configured such that items stored in the main storage compartment are accessible by opening the closure system (e.g., releasable fasteners) securing any one or more of the panels. Access may be allowed into the storage compartment from the top, bottom, left, or right side of the backpack, or any combination thereof, as opposed to limiting access from the top end of the backpack. Items stored within the accessory storage compartments are also accessible by opening any one or more of the fasteners or panels.

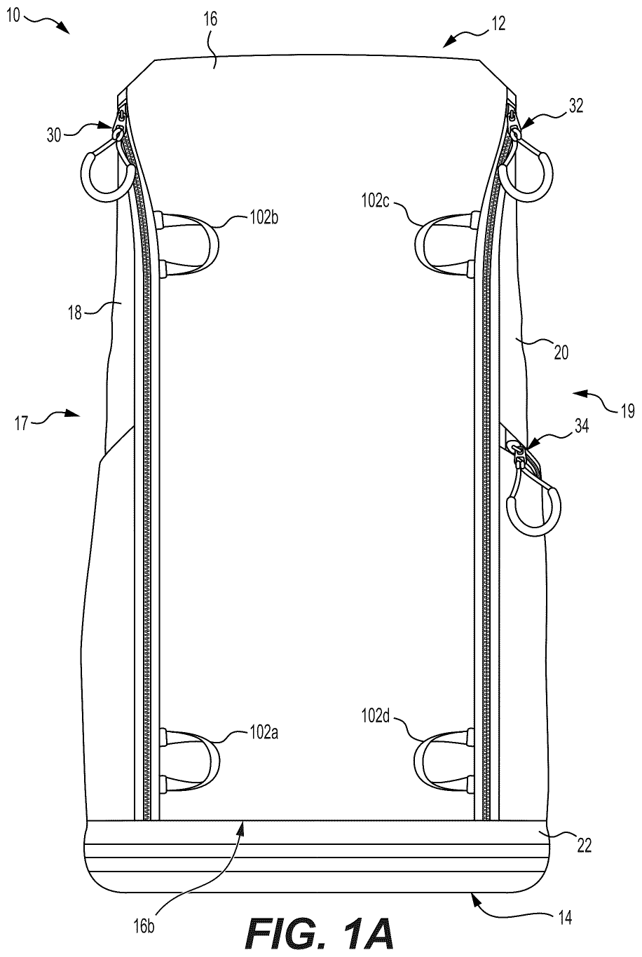

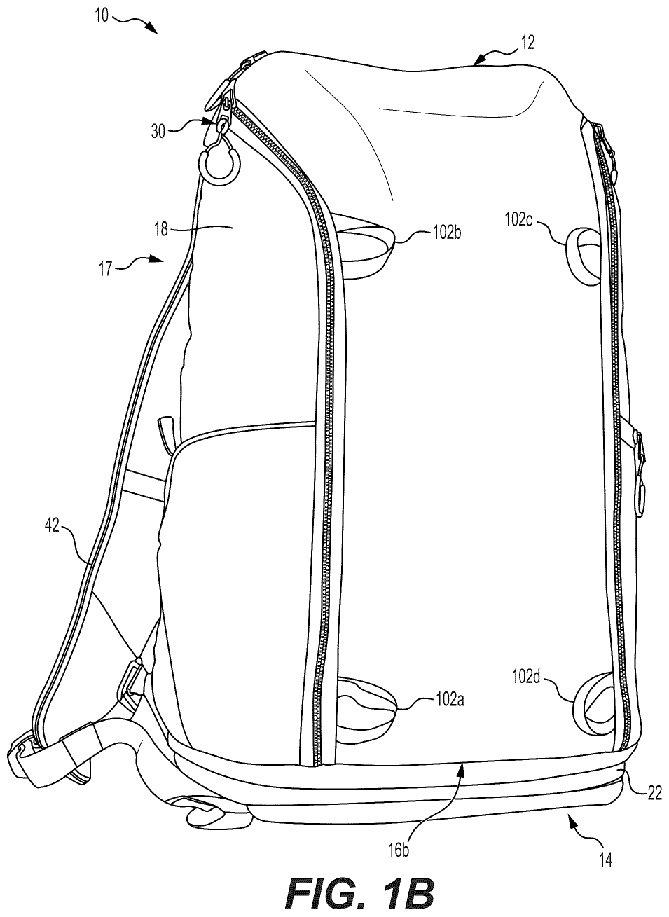

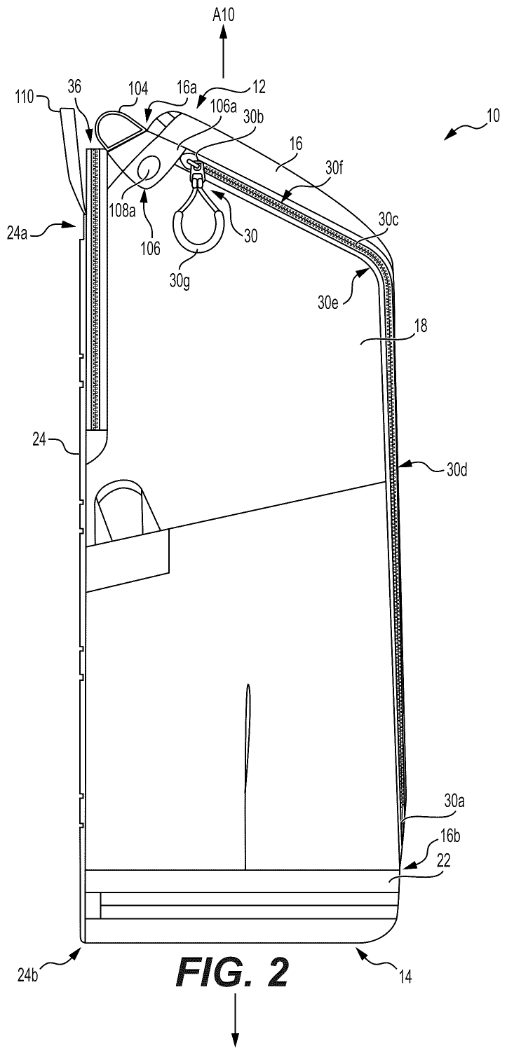

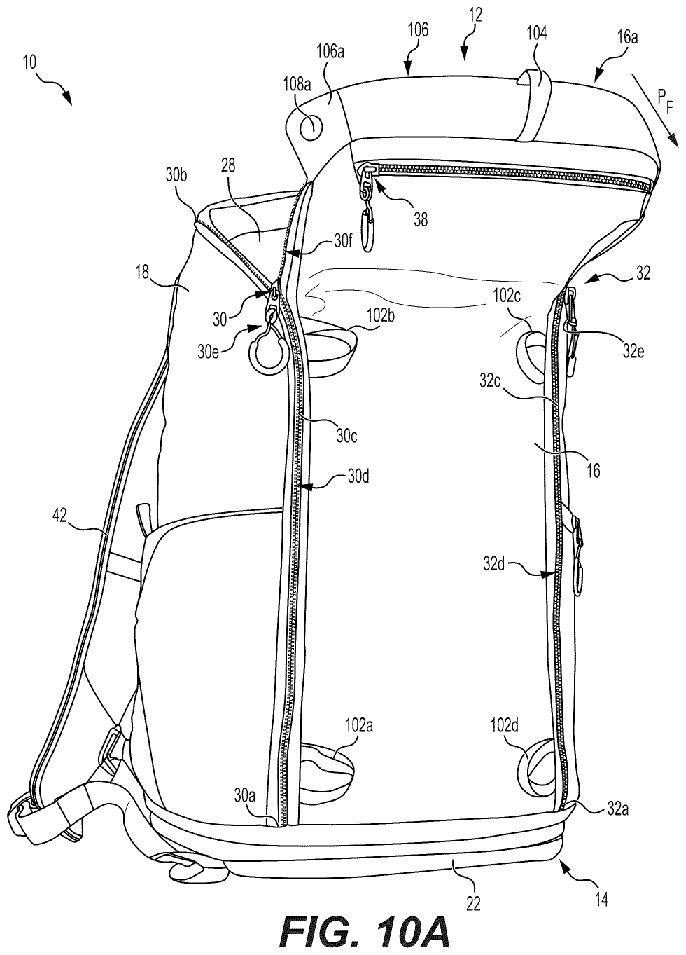

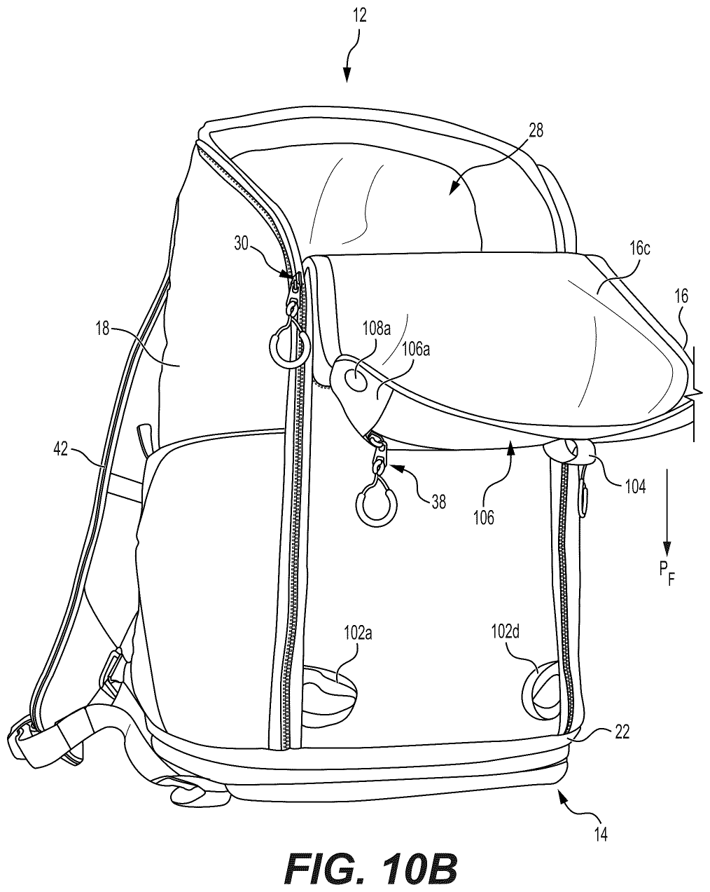

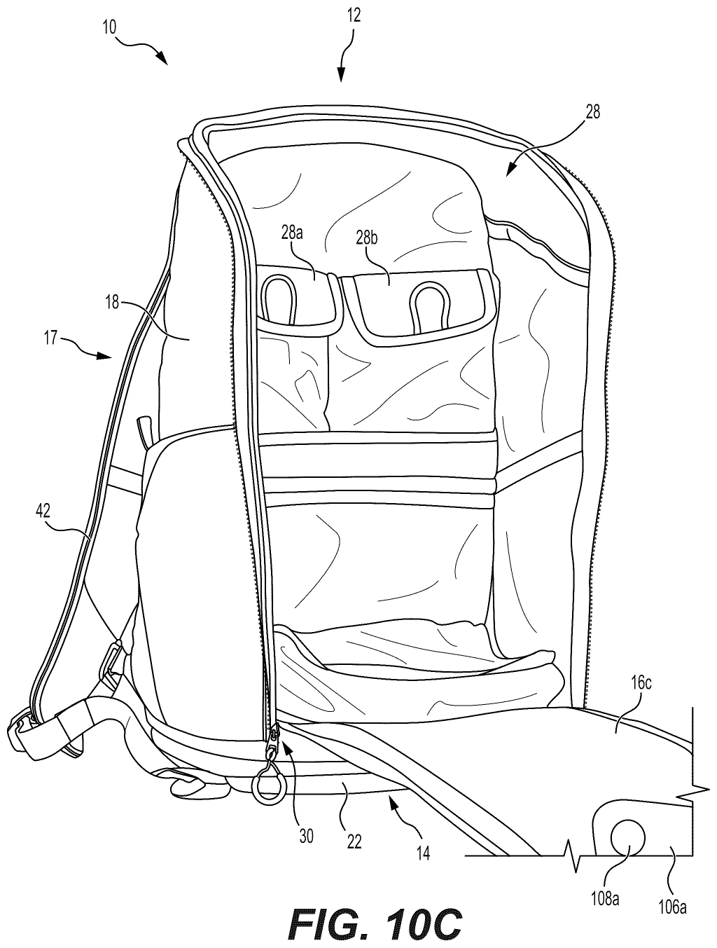

FIG. 1A depicts a bag 10. The bag 10 includes a top end 12 and a bottom end 14 that is positioned opposite of the top end 12. The bag 10 may include a first (front) panel 16, a first (left) wall 18, a second (right) wall 20, and a base 22. First panel 16 may be positioned between first wall 18 and second wall 20. Each of the first panel 16, the first wall 18, the second wall 20, and the base 22 may be coupled to a second (back) panel 24 (see FIG. 2). The first panel 16 has a longitudinal length that extends from a first end 16a (shown in FIG. 2) to a second end 16b. The first panel 16 generally opposes second panel 24, and the first panel 16 and second panel 24 at least partially enclose a main storage compartment 28 (shown in FIGS. 10A-10C). The first panel 16 is movable between a first (open) configuration and a second (closed) configuration, as will be described in greater detail herein. The first panel 16 reveals the main storage compartment 28 when positioned in the open configuration. In an example, the second panel 24 faces a user's back and the first panel 16 faces away from a user's back when worn by the user in the normal manner. In an example, the second panel 24 and the first panel 16 are asymmetrical with respect to a vertical plane A10 (shown in FIG. 2). The vertical plane A10 bisects the first panel 16 from the second panel 24.

In addition, the bag 10 has a closure system that includes one or more zippers 30, 32 that provide access to the main storage compartment 28 (shown in FIGS. 10A-10C) by way of the first panel 16. The closure system of the bag 10 may include one or more additional zippers 34 that provide access to additional portions of the bag 10. Each zipper 30, 32, 34 may extend along a zipper track, described in further detail below. For exemplary purposes, a closure system including zipper attachments are described and depicted in the figures, however, it should be appreciated that any suitable releasable fastener might be used to connect various panels and/or portions of the bag 10, such as snaps, hook-and-loop fastening strips, clips, and the like.

Still referring to FIG. 1A, the first panel 16 includes a plurality of loops 102a, 102b, 102c, 102d that are sized, shaped, and/or otherwise configured to be graspable by a user of the bag 10. The plurality of loops includes at least a first loop 102a, a second loop 102b, a third loop 102c, and a fourth loop 102d. The first loop 102a and the second loop 102b are disposed on a left side 17 of the bag 10 adjacent to the first wall 18, with the first loop 102a positioned proximate to the bottom end 14 and the second loop 102b positioned proximate to the top end 12. The third loop 102c and the fourth loop 102d are disposed on a right side 19 of the bag 10 adjacent to the second wall 20, with the third loop 102c positioned proximate to the top end 12 and the fourth loop 102d positioned proximate to the bottom end 14. The loops 102a, 102b, 102c, 102d may be configured and operable to aid a user in opening and closing the bag 10, and particularly the front panel 16. Although the plurality of loops 102a, 102b, 102c, 102d are shown and described herein at particular positions relative to the front panel 16, it should be appreciated that the loops 102a, 102b, 102c, 102d may be positioned at various other suitable locations along the first panel 16 and the bag 10 for aiding a user in opening and closing the bag 10.

Referring to FIG. 1B, the bag 10 may include one or more straps 42 that may be sized, shaped, and/or otherwise configured to facilitate securing the bag 10 to a user for ease in portability. The strap(s) 42 may include one or more features (e.g., cushions, mesh, etc.) that provide desired forms of comfortability or breathability. The strap(s) 42 may be integrally formed or separately connectable to the bag 10, as will be described in further detail herein.

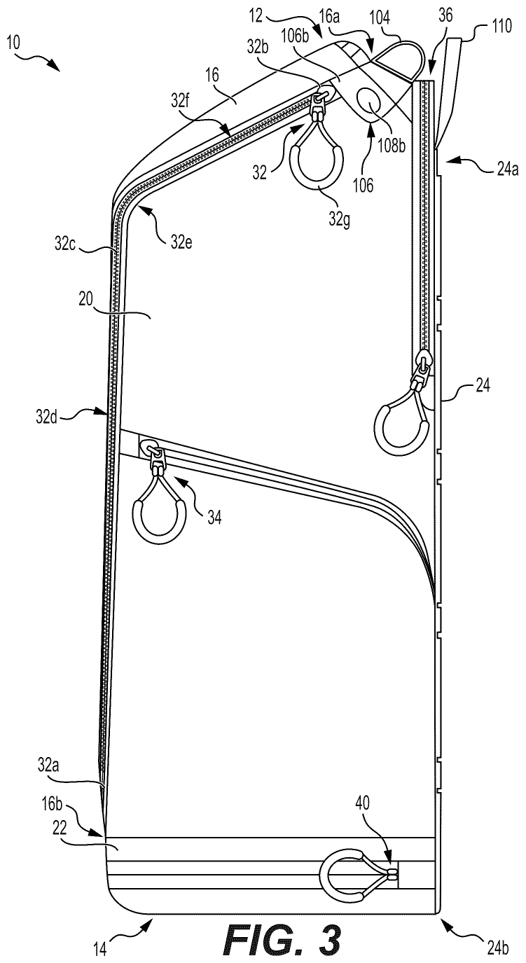

With reference to FIG. 2, the closure system of the bag 10 includes a top loop 104 and a fastener system 106 disposed at the first end 16a of the first panel 16. The closure system of the bag 10 further includes a first set of magnets 108a, 108b (shown in FIG. 3). The fastener system 106 includes a first end 106a disposed on the first wall 18 and adjacent to the zipper 30. The first end 106a includes a first magnet 108a of the first set of magnets 108a, 108b that is securely attached to (e.g., sewn into) the first end 106a of the fastener system 106. In other examples, the first magnet 108a may be disposed on an outer surface of the first end 106a. Each magnet 108a and 108b includes a magnet interface for engaging an opposing magnet.

The bag 10 may further include a zipper 36 that is disposed adjacent to the fastener system 106 and positioned between second panel 24 and each of the first wall 18, the second wall 20, and the first panel 16 (see FIGS. 2-6). Zipper 36 may extend from the top end 12 toward a portion of the first wall 18. In the example, zipper 36 does not extend along the full height of the first wall 18. The zipper 36 may be configured to provide access to the main storage compartment 28 of the bag 10. In other examples, zipper 36 may provide access to another compartment of the bag 10.

Still referring to FIG. 2, the second panel 24 may have a longitudinal length that extends from a first end 24a to a second end 24b. The first end 24a is disposed adjacent to the top end 12, and the second end 24b is disposed adjacent to the bottom end 14. The second panel 24 may include at least one loop 110 disposed adjacent to the first end 24a and the zipper 36. The at least one loop 110 may be sized, shaped, and/or otherwise configured to facilitate grasping the bag 10 at the top end 112, and particularly at the first end 24a of the second panel 24.

In the example, the zipper 30 extends from a starting position 30a disposed adjacent to the second end 16b near the bottom end 14 to a terminal position 30b disposed adjacent to the first end 16a near the top end 12 of the bag 10 and a back of the main storage compartment 28. The zipper 30 includes a plurality of teeth 30c that extends adjacent to the first wall 18. The plurality of teeth 30c of the zipper 30 extend between the starting position 30a and the terminal position 30b. The zipper 30 may include one or more regions/portions along a longitudinal length of a zipper track defined between the starting position 30a and the terminal position 30b, including a first portion 30d, a second portion 30f, and a transition region 30e positioned between the first portion 30d and the second portion 30f.

The plurality of teeth 30c extend along the first portion 30d, transition region 30e, and second portion 30f. The first portion 30d of the zipper 30 extending from the starting position 30a to the transition region 30e, and the second portion 30f extending from the transition region 30e to the terminal position 30b. The transition region 30e may be curved and/or angled relative to one or more of the first portion 30d and the second portion 30f. In some examples, the transition region 30e may define an obtuse and/or acute angle with one or more of the first portion 30d and the second portion 30f.

The closure system of the bag 10 may include an actuator in the form of a zipper pull 30g movably coupled to the zipper 30, and the zipper pull 30g may be configured to move from the starting position 30a to the terminal position 30b to attach the front panel 16 to the first wall 18, thereby at least partially closing the bag 10. The zipper pull 30g may be further configured to move from the terminal position 30b to the starting position 30a to detach the front panel 16 from the first wall 18, thereby at least partially opening the bag 10.

With reference to FIG. 3, the fastener system 106 includes a second end 106b disposed on the second wall 20 and adjacent to the zipper 32. The second end 106b includes a second magnet 108b of the first set of magnets 108a, 108b, and the second magnet 108b is securely attached to (e.g., sewn into) the second end 106b of the fastener system 106. In other examples, the second magnet 108b may be disposed on an outer surface of the second end 106b.

The zipper 36 is disposed adjacent to the fastener system 106 and positioned between the second panel 24 and each of the first wall 18, the second wall 20, and the first panel 16. Zipper 36 extends from the top end 12 toward a portion of the second wall 20. In the example, zipper 36 does not extend along the full height of the second wall 20. The zipper 32 extends from a starting position 32a disposed adjacent to the second end 16b near the bottom end 14 to a terminal position 32b disposed adjacent to the first end 16a near the top end 12 of the bag 10 and a back of the main storage compartment 28. The zipper 32 includes a plurality of teeth 32c that extends adjacent to the second wall 20. The plurality of teeth 32c of the zipper 32 extend between the starting position 32a and the terminal position 32b. The zipper 32 may include one or more regions/portions along a longitudinal length of a zipper track defined between the starting position 32a and the terminal position 32b, including a first portion 32d, a second portion 32f, and a transition region 32e positioned between the first portion 32d and the second portion 32f.

The plurality of teeth 32c extend along the first portion 32d, the transition region 32e, and the second portion 32f. The first portion 32d of the zipper 32 extending from the starting position 32a to the transition region 32e, and the second portion 32f extending from the transition region 32e to the terminal position 32b. The transition region 32e may be curved and/or angled relative to one or more of the first portion 32d and the second portion 32f. In some examples, the transition region 32e may form an obtuse and/or acute angle with one or more of the first portion 32d and the second portion 32f.

The closure system of the bag 10 includes an actuator in the form of a zipper pull 32g movably coupled to the zipper 32, and the zipper pull 32g may be configured to move from the starting position 32a to the terminal position 32b to attach the front panel 16 to the second wall 20, thereby at least partially closing the bag 10. The zipper pull 32g may be further configured to move from the terminal position 32b to the starting position 32a to detach the front panel 16 from the second wall 20, thereby at least partially opening the bag 10.

Still referring to FIG. 3, the base 22 may include a zipper 40. The base 22 may define an interior cavity (having an interior volume) that may be accessed via the zipper 40. The zipper 40 is configured to transition the base 22 between an open configuration and a closed configuration.

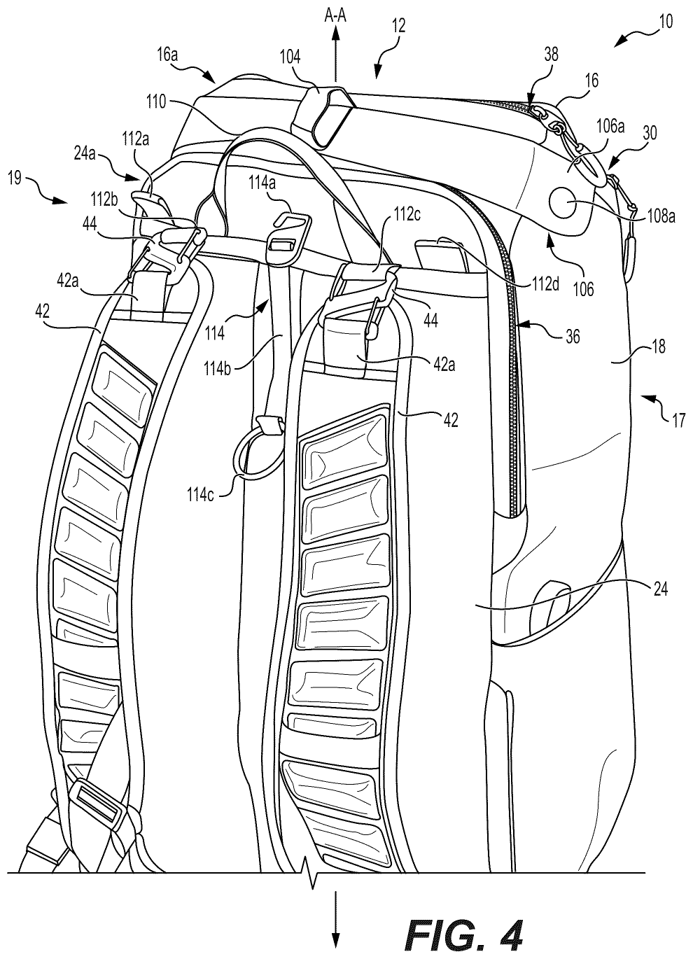

Referring to FIG. 4, the first end 16a of the first panel 16 may include a zipper 38 that is configured and operable to provide access to an inner cavity of the first panel 16. The zipper 38 may have a longitudinal length that extends from a first (right) side of the first end 16a of the first panel 16 to a second (left) side of the first end 16a of the first panel 16 that is opposite of the first (right) side. Similarly, the fastener system 106 may extend from the first (right) side of the first end 16a of the first panel 16 to the opposing second (left) side of the first end 16a of the first panel 16. The fastener system 106 is disposed between the terminal position 30b of the zipper 30 and the terminal position 32b of the zipper 32 such that the zippers 30, 32 operate on separate zipper tracks. In other words, zippers 30 and 32 are noncontiguous.

The first end 24a of the second panel 24 includes one or more of the plurality of loops 112a, 112b, 112c, 112d disposed from a first (right) side of the second panel 24 to a second (left) side of the second panel 24. For example, a first loop 112a may be disposed adjacent to the right side of the second panel 24. The first loop 112a may be a right-most loop of the one or more loops 112a, 112b, 112c, 112d. A second loop 112b may be disposed adjacent to the first loop 112a, and a third loop 112 may be disposed adjacent to the second loop 112b. A fourth loop 112d may be disposed adjacent to the left side of the second panel 24. The fourth loop 112d may be the left-most loop of the one or more loops 112a, 112b, 112c, 112d. In other words, loops 112a, 112d may positioned relative to the second panel 24 as a pair of outer loops of the one or more loops 112a, 112b, 112c, 112d, and loops 112b, 112c may be positioned relative to the second panel 24 as a pair of inner loops of the one or more loops 112a, 112b, 112c, 112d. Each of the one or more loops 112a, 112b, 112c, 112d may include a through hole configured to receive a corresponding element (e.g., a strap hook 44) for coupling the bag 10 to the one or more straps 42. In the example, loop 110 may extend from the second loop 112b and the third loop 112c.

The one or more loops 112a, 112b, 112c, 112d may be positioned along the second panel 24 to define a plurality of connection points for the one or more straps 42, such that the straps 42 may be selectively adjustable to connect to the second panel 24 at various suitable combinations of the loops 112a, 112b, 112c, 112d. In other words, the bag 10 may be modular in that the straps 42 may be coupled to one or more of the loops 112a, 112b, 112c, 112d. In the example, at least one strap 42 may be coupled to each of the second loop 112b and the third loop 112c. Although the bag 10 is shown and described herein as including four loops 112a, 112b, 112c, 112d, it should be appreciated that a number of loops of the second panel 24 may include any suitable number to couple a desired configuration or corresponding number of straps 42.

Still referring to FIG. 4, the straps 42 extend along the second panel 24 and are connected at or near the first end 24a. As an example, the bag 10 may include two straps 42, however, the bag 10 may include any number of straps 42 coupled to a respective loop 112a, 112b, 112c, 112d. Each of the straps 42 may be coupled to the respective loop 112a, 112b, 112c, 112d via a strap hook 44. The straps 42 may include a loop 42a that is configured to couple with at least one end of the strap hook 44. The strap hook 44 is releasably coupled to both the loop 42a of a respective strap 42 and a respective loop 112a, 112b, 112c, 112d of the bag 10, thereby coupling the strap 42 to the bag 10.

The strap hook 44, as will be described in greater detail below, includes two free ends that are each configured to connect to both of the strap 44 and the respective loop 112a, 112b, 112c, 112d. In other examples, various other suitable retention mechanisms might also be used in place of strap hook 44 to couple the straps 42 to the bag 10, such as one or more clips, snaps, hook-and-loop fastening strips, and the like. In further examples, the straps 42 might be coupled to other portions of the bag 10 than the second panel 24 and/or at other ends than the top end 12 (e.g., bottom end 14). Also, the straps 42 might be fixedly attached to the sides or bottom of the bag 10 in a non-adjustable manner. Straps 42 may be comprised of multiple layers of fabrics or materials, which may include but is not limited to, a mesh, a polyester, cotton, foam, silicon, air pockets, or any other fabric, padding material, or the like.

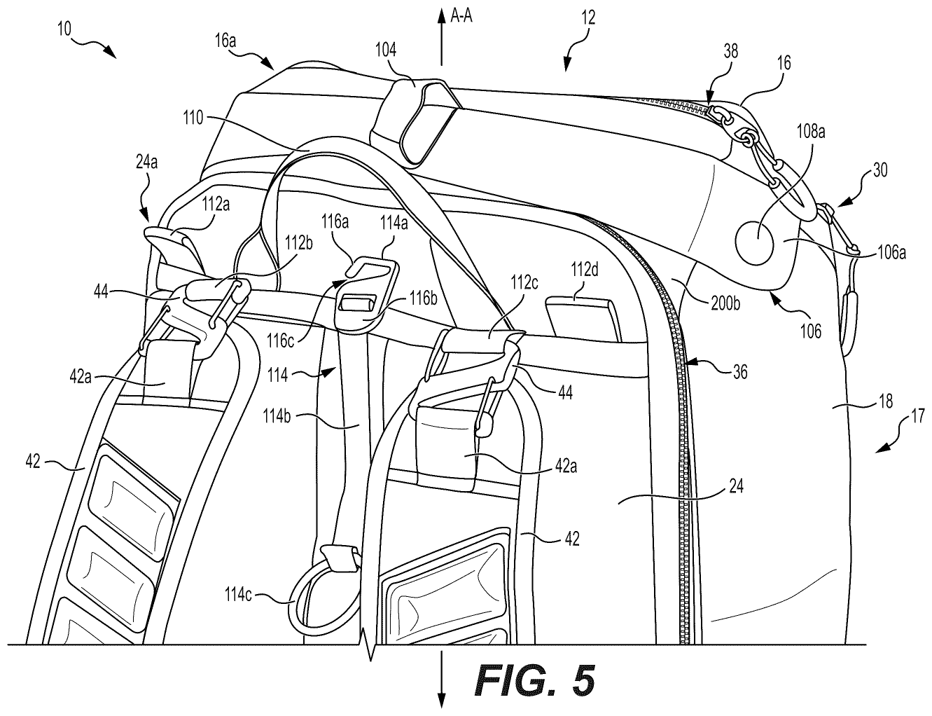

Still referring to FIG. 4, the second panel 24 includes a panel retention mechanism 114. The panel retention mechanism 114 may include a hook 114a, a strap 114b, and a ring 114c. The hook 114a may include a closed end (shown in FIG. 5) coupled to the strap 114b, and an end of the strap 114b opposite the end coupled to the hook 114a may be coupled to the ring 114c. As will be described in greater detail below, the panel retention mechanism 114 may be coupled to the second panel 24 such that the panel retention mechanism 114 is configured to translate parallel to an axis A-A extending vertically from the first end 24a to the second end 24b.

Referring to FIG. 5, the closure system of the bag 10 is in a first configuration in which the panel retention mechanism 114 is decoupled from the loop 104. As seen, the hook 114a of the panel retention mechanism 114 may include a free end 116a, a closed end 116b, and an opening 116c for facilitating connection between the panel retention mechanism 114 and the loop 104. In the example, the hook 114a may be substantially G-shaped.

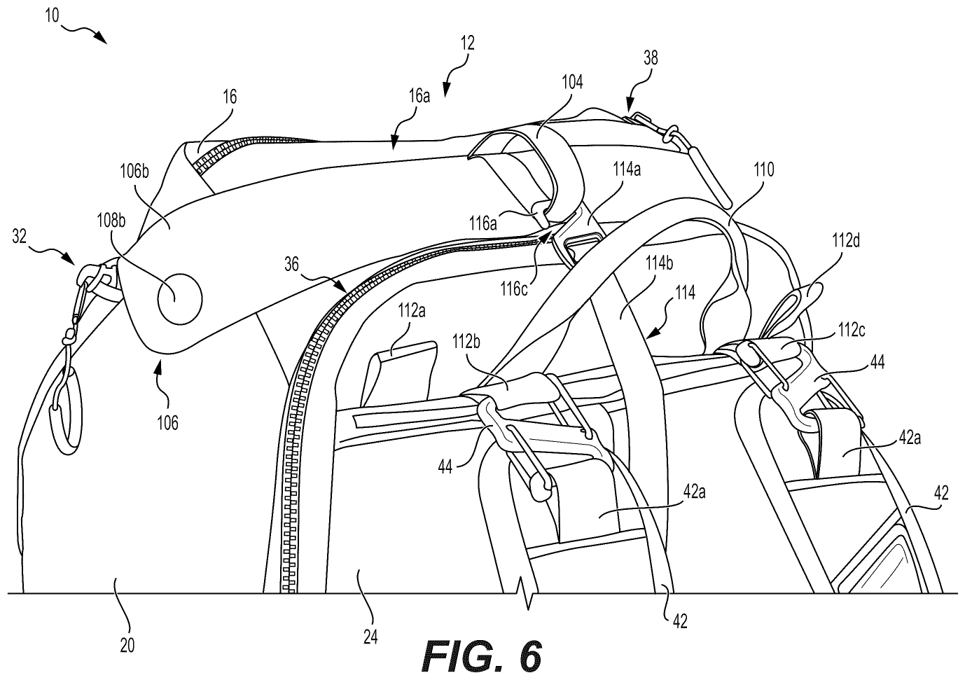

As shown in FIG. 6, the closure system of the bag 10 may be moved to a second configuration in which the panel retention mechanism 114 is coupled to the loop 104. In particular, the hook 114a may be configured to engage the loop 104 of the first panel 16, thereby coupling the second panel 24 to the first panel 16 (along an exterior of the fastener system 106) via the connection between the panel retention mechanism 114 and the loop 104. In other words, the panel retention mechanism 114 may be configured to translate vertically upward parallel to the axis A-A to allow the hook 114a to engage the loop 104. The loop 104 may be slidably received within the opening 116c and the free end 116a may securely engage the loop 104, thereby coupling the panel retention mechanism 114 thereto. The panel retention mechanism 114 may secure the bag 10 to the second configuration, with the first panel 16 in a closed state, by reducing the chances that first panel 16 comes loose during use of the bag 10.

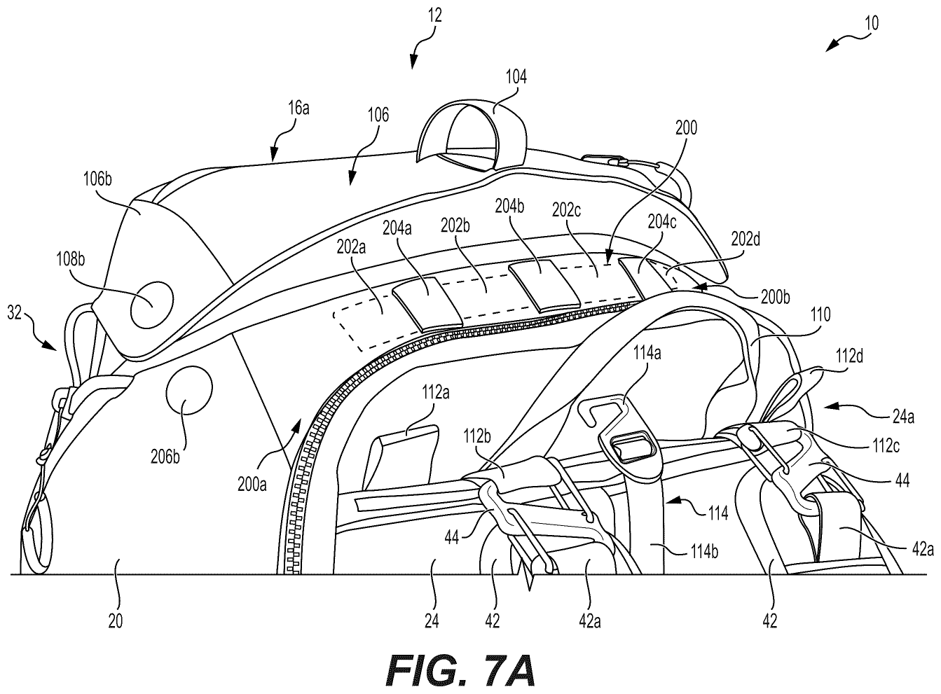

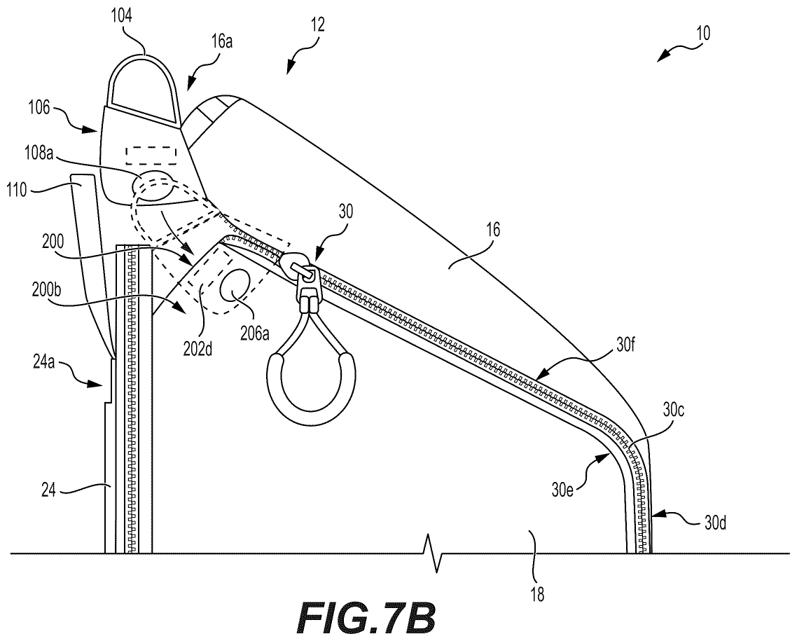

Referring to FIG. 7A, the closure system of the bag 10 may be moved to a third configuration in which the panel retention mechanism 114 is decoupled from the loop 104 and the fastener system 106 is decoupled from the second panel 24. In particular, the closure system of the bag 10 includes a closure interface region 200 along the top end 12. The closure interface region 200 may at least partially define a top surface of the main storage compartment 28.

The closure interface region 200 extends between the first wall 18 and the second wall 20. In the example, the closure interface region 200 includes a first set of magnets 202a, 202b, 202c, 202d and a plurality of fasteners 204a, 204b, 204c. The plurality of fasteners 204a, 204b, 204c are disposed between adjacent magnets 202a, 202b, 202c, 202d. For example, a first magnet 202a may be disposed on a first (right) end 200a of the closure interface region 200 and may define a right-most magnet of the first set of magnets 202a, 202b, 202c, 202d. A fourth magnet 202d may be disposed on a second (left) end 200b of the closure interface region 200 and may define a left-most magnet of the first set of magnets 202a, 202b, 202c, 202d. A second magnet 202b and a third magnet 202c may be disposed between the first magnet 202a and the fourth magnet 202d, with the second magnet 202b disposed adjacent to first magnet 202a and the third magnet 202c disposed adjacent to the fourth magnet 202d. A first fastener 204a of the plurality of fasteners 204a, 204b, 204c may be disposed between the first magnet 202a and the second magnet 202b, and a second fastener 204b of the plurality of fasteners 204a, 204b, 204c may be disposed between the second magnet 202b and the third magnet 202c. A third fastener 204c of the plurality of fasteners 204a, 204b, 204c may be disposed between the third magnet 202c and the fourth magnet 202d. In other words, the plurality of fasteners 204a, 204b, 204c may be disposed between adjacent pairs of magnets 202a, 202b, 202c, 202d. Each magnet 202a, 202b, 202c, 202d includes a magnet interface for engaging an opposing magnet. In other examples, any of the first set of magnets 202a, 202b, 202c, 202d may be a temporary magnet that includes a material (e.g. iron, tin, alloys, and other materials that are attracted to a magnet whether in their natural state or after magnetization) that is otherwise attracted to a magnet. In other words, any of the first set of magnets 202a, 202b, 202c, 202d may be temporary magnets that engage a permanent magnet.

The plurality of fasteners 204a, 204b, 204c may include hook and loop fasteners. The plurality of fasteners 204a, 204b, 204c may be configured to engage with a corresponding fastener of the first panel 16 when the first panel 16 is in the closed configuration, as described in further detail below. The first set of magnets 202a, 202b, 202c, 202d may be embedded or otherwise attached to (e.g., sewn into) the top end 12 of the bag 10. The first set of magnets 202a, 202b, 202c, 202d may be configured to mate with a corresponding magnet of the first panel 16, as described in further detail below.

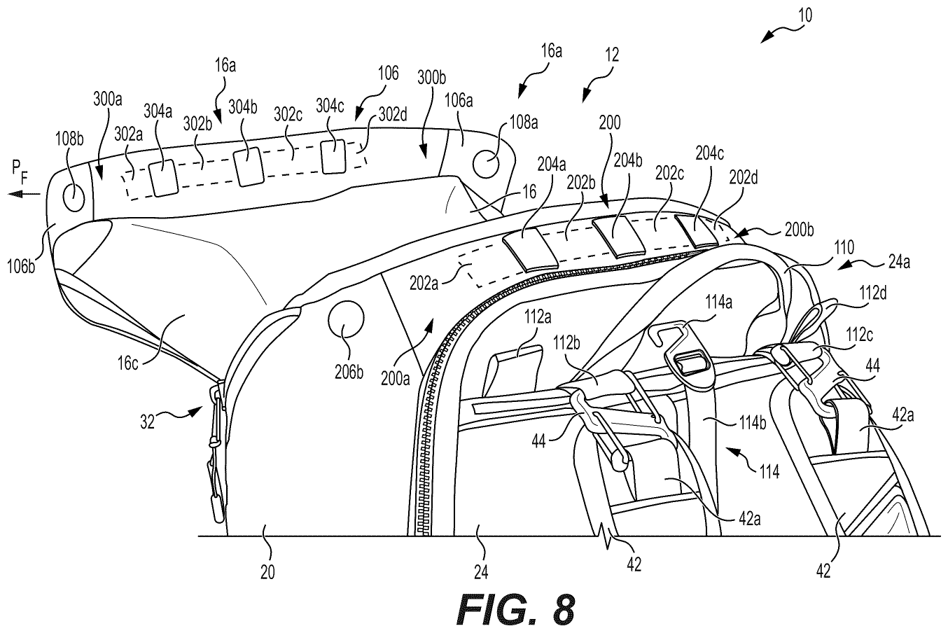

As seen in FIG. 8, the closure system of the bag 10 is moved to a fourth configuration in which the fastener system 106 is further separated from the closure interface region 200. The first wall 18 and the second wall 20 include a second set of magnets 206a, 206b. A first magnet 206a of the second set of magnets 206a, 206b is disposed on the first wall 18 adjacent to the second end 200b of the closure region 200. The first magnet 206a is configured to mate with the first magnet 108a of the fastener system 106 when the first panel 16 is in the closed position. The first magnet 206a is embedded or otherwise attached to (e.g., sewn into) the first wall 18. A second magnet 206b of the second set of magnets 206a, 206b is disposed on the second wall 20 adjacent to the first end 200a of the closure region 200. The second magnet 206b is configured to mate with the second magnet 108b of the fastener system 106. The second magnet 206b is embedded or otherwise attached to (e.g., sewn into) the second wall 20. Each magnet 206a, 206b includes a magnet interface for engaging an opposing magnet. In other examples, any of the second set of magnets 206a, 206b may be a temporary magnet that includes a material (e.g. iron, tin, alloys, and other materials that are attracted to a magnet whether in their natural state or after magnetization) that is otherwise attracted to a magnet. In other words, any of the second set of magnets 206a, 206b may be temporary magnets that engage a permanent magnet.

With continued reference to FIG. 8, the first panel 16 may be movable between the closed configuration (FIGS. 5-6 and 7B) and the open configuration (FIGS. 7A and 8). The fastener system 106 of the first panel 16 includes a first plurality of magnets 302a, 302b, 302c, 302d and a plurality of fasteners 304a, 304b, 304c. The plurality of fasteners 304a, 304b, 304c are disposed between adjacent magnets of the plurality of magnets 302a, 302b, 302c, 302d.

A first magnet 302a may be disposed on a first (right) end 300a of the fastener system 106. First magnet 302a may be disposed adjacent to the second end 106b. First magnet 302a defines a right-most magnet of the plurality of magnets 302a, 302b, 302c, 302d. A fourth magnet 302d may be disposed on a second (left) end 300b of the fastener system 106. Fourth magnet 302d may be disposed adjacent to the first end 106a. Fourth magnet 302d defines a left-most magnet of the plurality of magnets 302a, 302b, 302c, 302d. A second magnet 302b and a third magnet 302c may be disposed between the first magnet 302a and the fourth magnet 302d. Second magnet 302b may be disposed adjacent to first magnet 302a. Third magnet 302c may be disposed adjacent to fourth magnet 302d. A first fastener 304a of the plurality of fasteners 304a, 304b, 304c may be disposed between first magnet 302a and second magnet 302b. A second fastener 304b of the plurality of fasteners 304a, 304b, 304c may be disposed between second magnet 302b and third magnet 302c. A third fastener 304c of the plurality of fasteners 304a, 304b, 304c may be disposed between the third magnet 302c and fourth magnet 302d. In other words, the plurality of fasteners 304a, 304b, 304c may be disposed between adjacent pairs of magnets 302a, 302b, 302c, 302d. Each magnet 302a, 302b, 302c, 302d includes a magnet interface for engaging an opposing magnet. In other examples, any of the first plurality of magnets 302a, 302b, 302c, 302d may be a temporary magnet that includes a material (e.g. iron, tin, alloys, and other materials that are attracted to a magnet whether in their natural state or after magnetization) that is otherwise attracted to a magnet. In other words, any of the first plurality of magnets 302a, 302b, 302c, 302d may be temporary magnets that engage a permanent magnet.

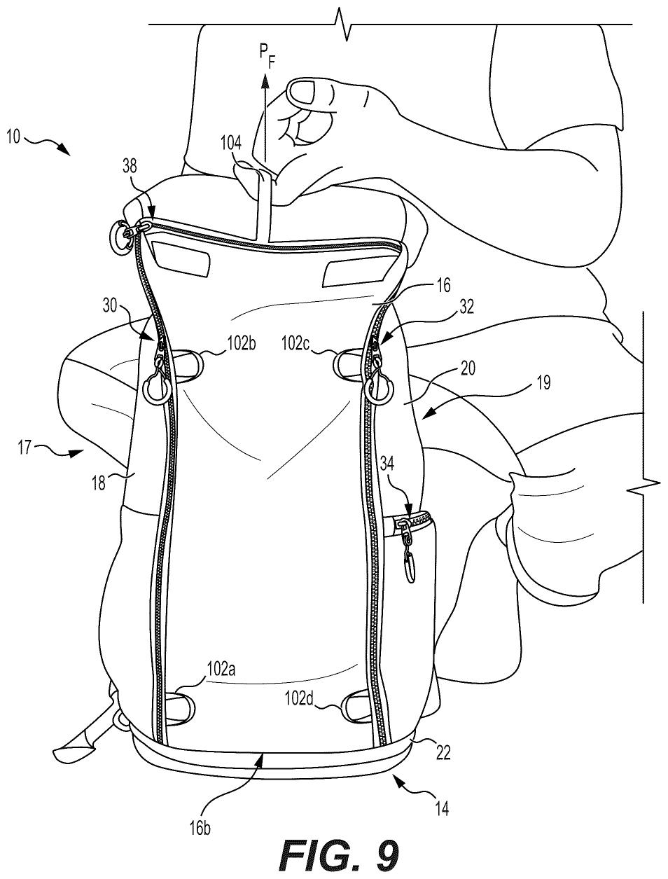

In the open configuration of the first panel 16, the fastener system 106 opens parallel to a pulling force Pt. The pulling force Pt occurs when a user of the bag 10 opens the first panel 16 from the second panel 24, such as by using the loop 104 (see FIG. 9). The user pulls fastener system 106 away from the closure interface region 200 such that an inner surface 16c of the first panel 16 (disposed adjacent to the main compartment 28) is pulled away from second panel 24 to reveal the main compartment 28 (shown in FIGS. 10A-10B). When the first panel 16 is pulled radially outward from the second panel 24, each magnet 302a, 302b, 302c, 302d may be released from its respective magnetic connection with each corresponding magnet 202a, 202b, 202c, 202d. Each fastener 304a, 304b, 304c may be released from its respective connection with each corresponding fastener 204a, 204b, 204c. Additionally, each magnet 108a, 108b may be released from its respective magnetic connection with each corresponding magnet 206a, 206b. Further, as the first panel 16 is moved away from the top end 12 and walls 18, 20, the zippers 30, 32 may be transitioned from a closed (zipped) configuration to an opened (unzipped) configuration. By facilitating entry of the bag 10 via use of the single loop 104 to disconnect the various components of the closure system, a user can open the bag 10 without needing to use two hands (as further shown in FIG. 9).

FIGS. 9-10C depict the bag 10 moving through various stages in response to a user opening the bag 10 via the loop 104 (see FIG. 9). As the first panel 16 is moved away from the second panel 24, the main compartment 28 of the bag 10 is revealed from the top end 12 (see FIG. 9). Continued application of a pulling force onto the loop 104 allows the first end 16a of the first panel 16 to be moved from the top end 12 toward the bottom end 14, thereby revealing more portions of the main compartment 28 (see FIG. 10B). As shown in FIG. 10C, the main compartment 28 may include one or more pockets 28a, 28b and/or other subcomponents disposed therein. Pockets 28a, 28b may define an interior volume configured to receive an item or object therein.

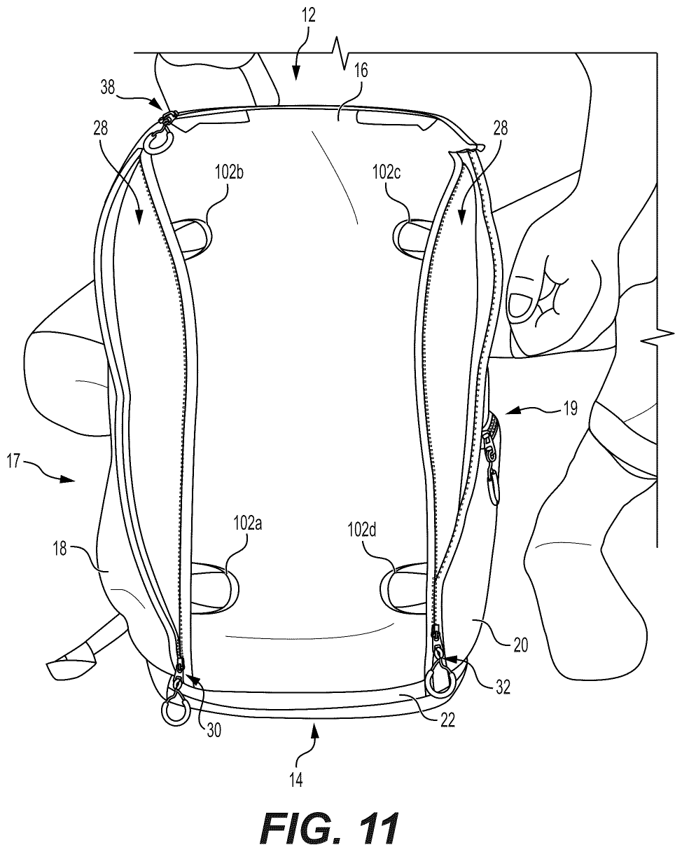

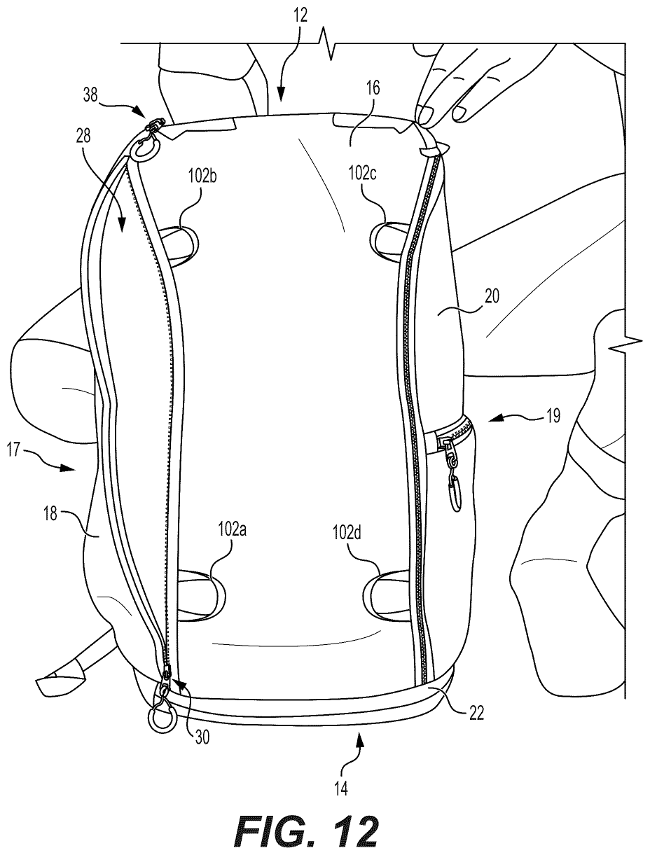

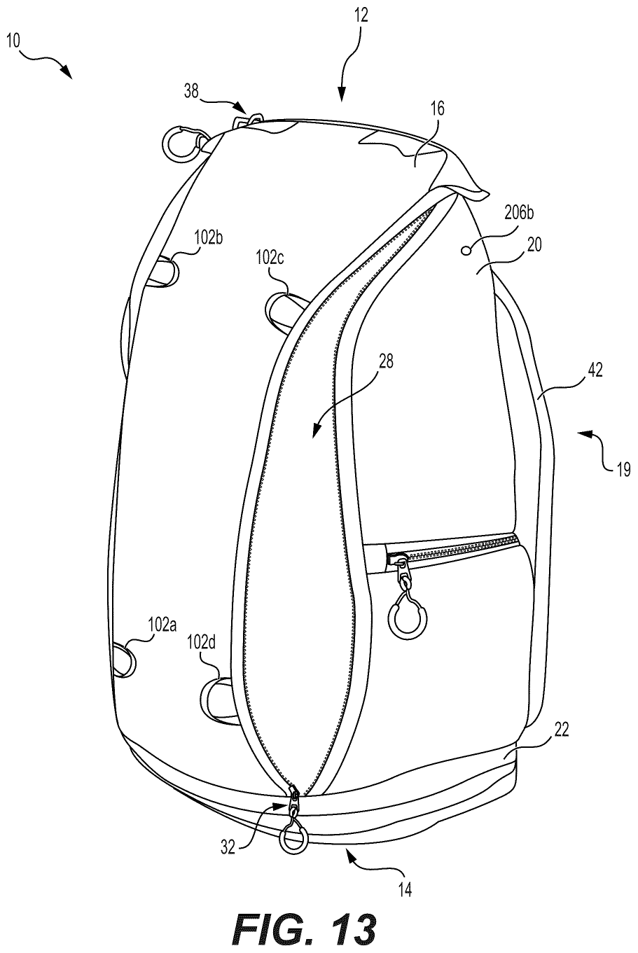

As shown in FIG. 11, the first panel 16 may be moved to a partially closed configuration, in which the fastener system 106 is engaged with the closure interface region 200, thereby securing the first panel 16 to the second panel 24 of the bag 10. In the partially closed configuration, the first panel 16 may cover a majority of the main compartment 28, but the main compartment 28 may still be accessed from the left side 17 or the right side 19 due to one or more of the zippers 30, 32 being actuated to an opened state. In other words, the zippers 30, 32 may be at least partially opened (e.g., not fully zipped closed) when the first panel 16 is moved to the partially closed configuration. The zippers 30, 32 are able to close (e.g., zip) independent of one another such that the main compartment 28 may be accessed on only the left side 17 (shown in FIG. 12) or only the right side 19 (shown in FIG. 13).

For exemplary purposes, the panels 16, 24 and the walls 18, 20 may be generally rectangular in shape, or alternatively include a rounded-rectangular shape. In other examples, the shape of the panels 16, 24 and the walls 18, 20 may include any other suitable shapes, such as triangular, squared, circular, polygonal, etc. Further, an overall shape of the bag 10 may generally be rectangular, as depicted, or may be any other appropriate shape such as trapezoidal, ovular, circular, polygonal, etc.

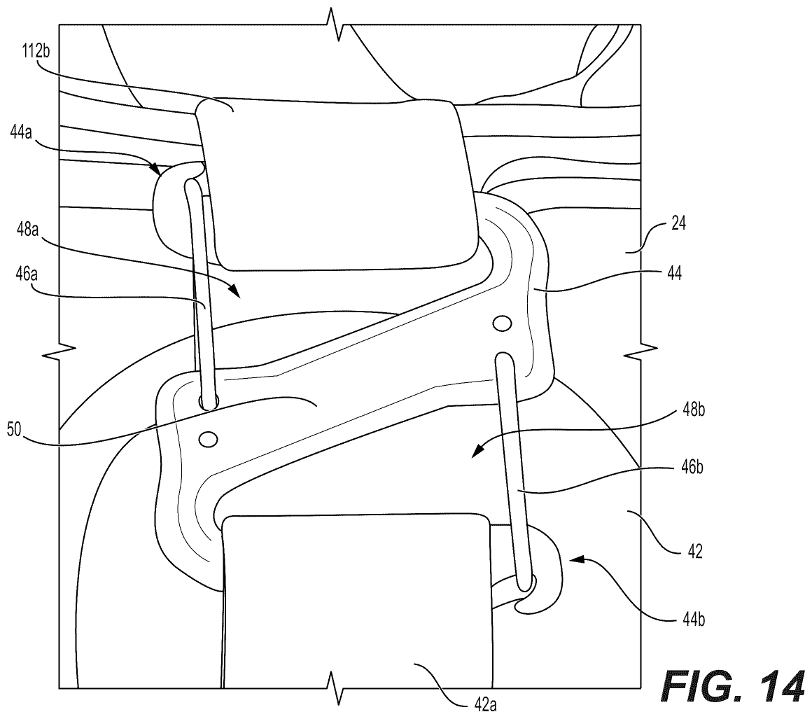

Referring to FIG. 14, the strap hook 44 may include at least two free ends 44a, 44b, one or more clips 46a, 46b, a pair of openings 48a, 48b, and a hook base 50. In the example, the strap hook 44 may be Z-shaped or S-shaped. The free ends 44a, 44b are not sewn or otherwise permanently closed or affixed to any other element of the bag 10. A first clip 46a may be configured to engage a first free end 44a, and a second clip 46b may be configured to engage a second free end 44b, as will be described in greater detail below. The pair of openings 48a, 48b may be configured to receive at least one of the loops 112a, 112b, 112c, 112d or the loop 42a of the straps 42. In some examples, the strap hook 44 may be G-shaped, have a substantially ovular shape, or any other suitable shape for connecting straps 42 to any one of the one or more loops 112a, 112b, 112c, and 112d.

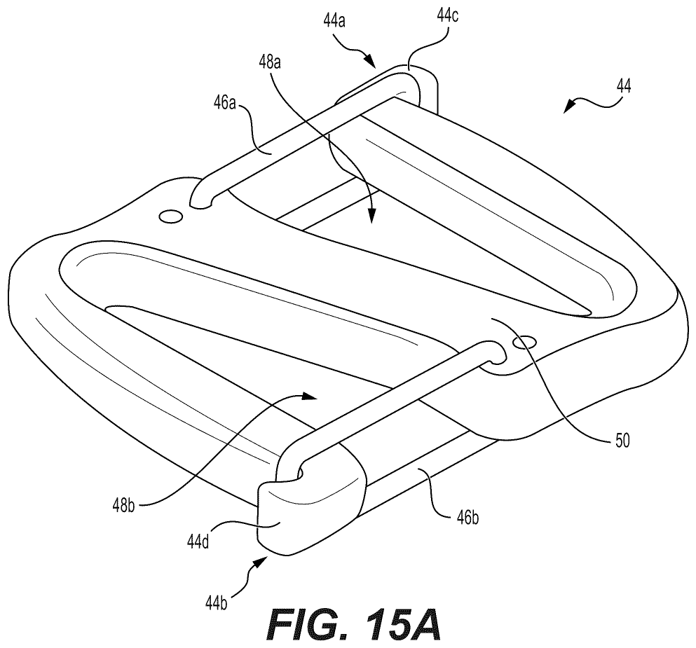

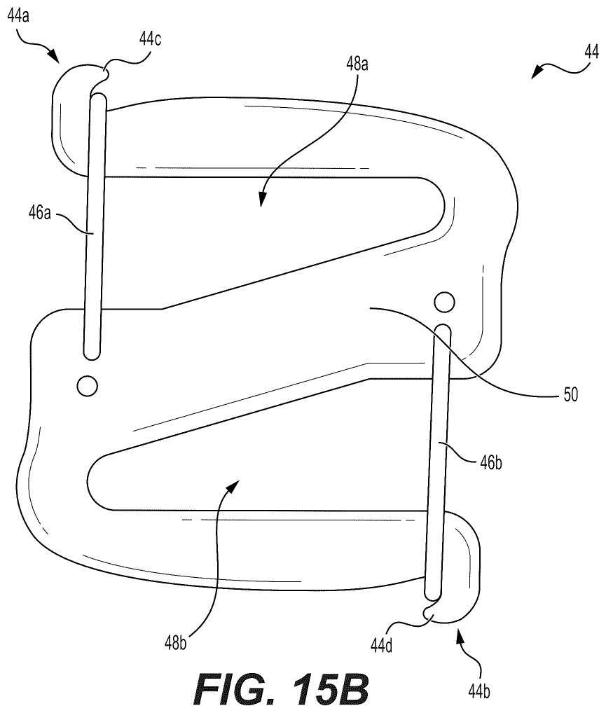

Referring to FIGS. 15A-15B, the strap hook 44 includes a first flange 44c disposed at the first free end 44a. The strap hook 44 includes a second flange 44d disposed at the second free end 44b. It should be appreciated that each of the free ends 44a, 44b may define adjustable arms of the strap hook 44. The first flange 44c may be configured to retain the first clip 46a on the strap hook 44 when the first clip 46a is coupled to the first free end 44a in a closed position. The second flange 44d may be configured to retain the second clip 46b on the strap hook 44 when the second clip 46b is coupled to the second free end 44b in a closed position. In order to move the strap hook 44 to an open position for receiving any of the one or more loops 112a, 112b, 112c, 112d or the loop 42a of the straps 42, a user may depress one or more of the free ends 44a, 44b and/or the flanges 44c, 44d inward toward the hook base 50 to disengage the clips 46a, 46b from the respective free ends 44a, 44b and/or flanges 44c, 44d, such that the clips 46a, 46b are no longer retained by the flanges 44c, 44d. In an example, the user may depress the first flange 44c to transition the first clip 46a to an open position, such that only the first free end 44a may be capable of receiving any of the one or more loops 112a, 112b, 112c, 112d or the loop 42a of the straps 42 into the opening 48a. In another example, the user may depress the second flange 44d to transition the second clip 46b to an open position, such that only the second free end 44b may be capable of receiving any of the one or more loops 112a, 112b, 112c, 112d or the loop 42a of the straps 42 into the opening 48b. In a further example, the user may depress both the flanges 44c, 44d such that both the first free end 44a and the second free end 44b may be capable of receiving any of the one or more loops 112a, 112b, 112c, 112d or the loop 42a of the straps 42 into either of the openings 48a, 48b.

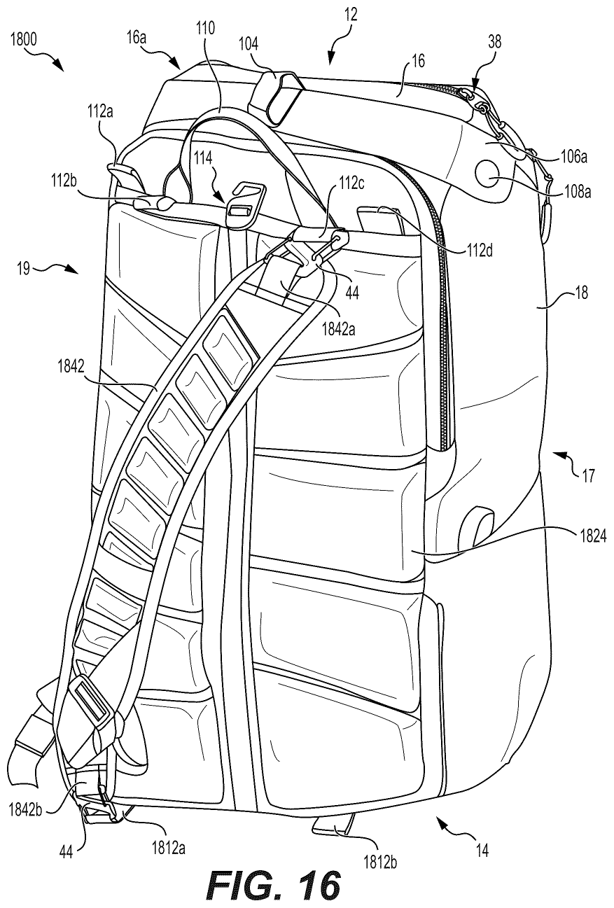

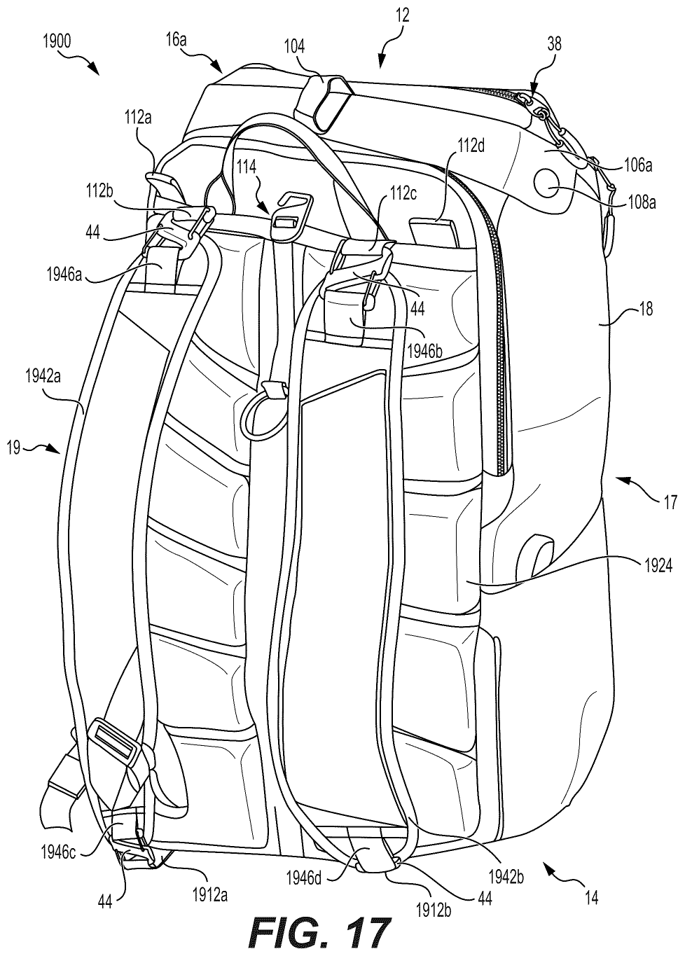

An alternate configuration of a bag 1800 is shown in FIG. 18. It should be understood that bag 1800 may be substantially similar to the bag 10 shown and described above, such that like reference numerals are used to identify like components. The bag 1800 may include a single strap 1842 along a second (rear) panel 1824 of the bag 1800. The strap 1842 may include a loop 1842a at an upper end of the strap 1842 adjacent to the top end 12 and a loop 1842b at a bottom end of the strap 1842 adjacent to the bottom end 14. The strap 1842 may be coupled to any one of the one or more loops 112a, 112b, 112c, 112d in a similar manner as shown and described above with respect to straps 42. In an example, the loop 1842a of strap 1842 may be coupled to loop 112a via the strap hook 44. In an example, the loop 1842a of strap 1842 may be coupled to loop 112b via the strap hook 44. In an example, the loop 1842a of strap 1842 may be coupled to loop 112c via the strap hook 44. In an example, the loop 1842a of strap 1842 may be coupled to loop 112d via the strap hook 44. In examples, the strap hook 44 may be sized and/or shaped as a Z-Hook (i.e., Z-shaped), as described with respect to FIGS. 16-17B. In other examples, the strap hook 44 may be sized and/or shaped as a G-Hook (i.e., G-shaped), a J-Hook (i.e., J-shaped), a swivel hook, or various other suitable shapes for connecting the strap 1842 to one or more portions of the bag 1800. The G-Hook, as opposed to the strap hook 44, includes one free/adjustable end and one sewn/fixed end.

An opposite, bottom end of the strap 1842 may be further coupled to one of either a loop 1812a disposed on the back panel 1824 adjacent to the right side 19 or a loop 1812b disposed on the back panel 1824 adjacent to the left side 17 via the strap hook 44. Accordingly, it should be appreciated that the strap 1842 may be coupled to the bag 1800 along the back panel 1824 via various combinations between the loops 112a, 112b, 112c, 112d along the top end 12 and the loops 1812a, 1812b along the bottom end 14. In an example, the strap 1842 may be coupled from loop 112a to loop 1812a. In an example, the strap 1842 may be coupled from loop 112b to loop 1812a. In an example, the strap 1842 may be coupled from loop 112c to loop 1812a. In an example, the strap 1842 may be coupled from loop 112d to loop 1812a. In an example, the strap 1842 may be coupled from loop 112a to loop 1812b. In an example, the strap 1842 may be coupled from loop 112b to loop 1812b. In an example, the strap 1842 may be coupled from loop 112c to loop 1812b. In an example, the strap 1842 may be coupled from loop 112d to loop 1812b. It should be appreciate that the back panel 1824 may include any number of loops 112a, 112b, 112c, 112d adjacent to the top end 12 and any number of loops 1812a, 1812b adjacent to the bottom end 14. Further, the back panel 1824 may include additional straps 1842 suitable for a desired form of transportation of bag 1800.

An alternate configuration of a bag 1900 is shown in FIG. 19. It should be understood that bag 1900 may be substantially similar to the bag 10 shown and described above, such that like reference numerals are used to identify like components. The bag 1900 may include one or more straps 1942a, 1942b along a back panel 1924 of the bag 1900. In the example, the bag 1900 may include a pair of straps 1942a, 1942b, and a first strap 1942a may include a loop 1946a and a loop 1946d and a second strap 1942b may include a loop 1946b and a loop 1946d. The pair of straps 1942a, 1942b may be coupled to the one or more loops 112a, 112b, 112c, 112d in a similar manner as the straps 42 shown and described above (e.g., via the strap hook 44). In an example, the loop 1946a of strap 1942a may be coupled to loop 112a via the strap hook 44. In an example, the loop 1946b of strap 1942b may be coupled to any of loops 112b, 112c, or 112d via the strap hook 44 when strap 1942a is coupled with loop 112a. In the example, the loop 1946a of strap 1942a may be coupled to loop 112b via the strap hook 44. In an example, the loop 1946b of strap 1942b may be coupled to any of loops 112a, 112c, or 112d via the strap hook 44 when strap 1942a is coupled with loop 112b. In an example, the loop 1946a of strap 1942a may be coupled to loop 112c via the strap hook 44. In an example, the loop 1946b of strap 1942b may be coupled to any of loops 112a, 112b, or 112d via the strap hook 44 when strap 1942a is coupled with loop 112c. In an example, the loop 1949a of strap 1942a may be coupled to loop 112d via the strap hook 44. In an example, the loop 1946b of strap 1942b may be coupled to any of loops 112a, 112b, or 112c via the strap hook 44 when strap 1942a is coupled with loop 112d.

The one or more straps 1942a, 1942b may be further coupled to one of either a loop 1912a disposed on the back panel 1924 adjacent to the right side 19 or a loop 1912b disposed on the back panel 1924 adjacent to the left side 17. In an example, the loop 1946c of strap 1942a may be coupled to loop 1912a via the strap hook 44. In an example, the loop 1946d of strap 1942b may be coupled to loop 1912b via the strap hook 44. It should be appreciated that the straps 1942a, 1942b may be coupled to the bag 1900 along the back panel 1924 via various combinations between the loops 112a, 112b, 112c, 112d along the top end 12 and the loops 1912a, 1912b along the bottom end 14. In the example, the strap 1942a may be coupled from loop 112a to loop 1912a. In an example, the strap 1942b may be coupled from any of loops 112b, 112c, or 112d to loop 1912b when strap 1942a is coupled from loop 112a to loop 1912a. In an example, the strap 1942a may be coupled from loop 112b to loop 1912a. In an example, the strap 1942b may be coupled from any of loops 112a, 112c, or 112d to loop 1912b when strap 1942a is coupled from loop 112b to loop 1912a. In an example, the strap 1942a may be coupled from loop 112c to loop 1912a. In an example, the strap 1942b may be coupled from any of loops 112a, 112b, or 112d to loop 1912b when strap 1942a is coupled from loop 112c to loop 1912a. In an example, the strap 1942a may be coupled from loop 112d to loop 1912a. In an example, the strap 1942b may be coupled from any of loops 112a, 112b, or 112c to loop 1912b when strap 1942a is coupled from loop 112d to loop 1912a. In an example, the strap 1942a may be coupled from loop 112a to loop 1912b. In an example, the strap 1942b may be coupled from any of loops 112b, 112c, or 112d to loop 1912a when strap 1942a is coupled from loop 112a to loop 1912b. In an example, the strap 1942a may be coupled from loop 112b to loop 1912b. In an example, the strap 1942b may be coupled from any of loops 112a, 112c, or 112d to loop 1912b when strap 1942a is coupled from loop 112b to loop 1912b. In an example, the strap 1942a may be coupled from loop 112c to loop 1912b. In an example, the strap 1942b may be coupled from any of loops 112a, 112b, or 112d to loop 1912b when strap 1942a is coupled from loop 112c to loop 1912b. In an example, the strap 1942a may be coupled from loop 112d to loop 1912b. In an example, the strap 1942b may be coupled from any of loops 112a, 112b, or 112c to loop 1912b when strap 1942a is coupled from loop 112d to loop 1912b. It should be appreciated that the back panel 1924 may include any number of loops 112a, 112b, 112c, 112d adjacent to the top end 12 and any number of loops 1912a, 1912b adjacent to the bottom end 14. Further, the back panel 1924 may include additional and/or fewer straps 1942a, 1942b suitable for a desired form of transportation of the bag 1900.

The bag 10 may include additional accessory compartments. Generally, accessory compartment openings might be releasably fastened by way of a closure system that may include any combination of zippers or any other appropriate fastener, such as snaps, hook-and-loop fastening strips, clips, and the like. Many other accessory compartment configurations are also possible, including compartments designed to secure specific items, such as water bottles, keys, pens, pencils, cellular phones, towels, athletic gear, uniforms, footwear, and the like. Accessory compartments may be comprised of any appropriate fabric or material, such as polyester, mesh, cotton, rubber, or the like.

The bag 10 may include other stowage mechanisms might also be included in the main compartment. For example, a footwear-stowage mechanism might be constructed within the main storage compartment, such as against the inside surface of the back wall. The footwear-stowage mechanism might be constructed in a manner to allow for footwear to be quickly and securely stored and easily retrieved, and in one aspect, the footwear-stowage mechanism includes one or more retention straps.

As described herein, the bags 10, 1800, 1900 include structural features that enable a user to operate the bags 10, 1800, 1900 with ease using one hand, such as via the closure system including a combination of the loop 104, the fastener system 106, the closure interface region 200, the first panel 16, the zippers 30, 32, the first set of magnets 108a, 108b, and the second set of magnets 206a, 206b. As such, the bags 10, 1800, 1900 may enable users of limited dexterity to operate the bags 10, 1800, 1900 via the closure system shown and described above. Additionally, the bags 10, 1800, and 1900 may not include permanently affixed or stitched straps 42 such that a user of the bags 10, 1800, and 1900 may interchange the straps 42 for a suitable configuration or use. It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

The following clauses provide an exemplary configuration for an article of footwear and sole structure described above.

Clause 1. A bag comprising: a back panel extending from a bottom end toward a top end, the back panel including: a plurality of loops disposed along the top end and the bottom end; at least one detachable strap; at least two fasteners, each of the at least two fasteners being attachable to the at least one detachable strap, wherein each fastener is able to be detachably coupled to the back panel via at least one of the plurality of loops.

Clause 2. The bag of clause 1, wherein the plurality of loops includes six loops; wherein a first loop of the plurality of loops is positioned at a first side of the back panel on the top end, a second loop of the plurality of loops is positioned at the first side of the back panel on the top end adjacent to the first loop of the plurality of loops, a third loop of the plurality of loops is positioned at a second side of the back panel on the top end, a fourth loop of the plurality of loops is positioned at the second side of the back panel on the top end adjacent to the third loop, a fifth loop of the plurality of loops is positioned at the first side of the back panel at the bottom end, and a sixth loop of the plurality of loops is positioned at the second side of the back panel at the bottom end.

Clause 3. The bag of clause 2, wherein the first loop of the plurality of loops is disposed adjacent to an outermost edge of the first side of the back panel, and the fourth loop of the plurality of loops is disposed adjacent to an outermost edge of the second side of the back panel.

Clause 4. The bag of clause 3, wherein the second loop of the plurality of loops is disposed adjacent to the first loop of the plurality of loops, and the third loop of the plurality of loops is disposed adjacent to the fourth loop of the plurality of loops.

Clause 5. The bag of clause 4, wherein the fifth loop of the plurality of loops is disposed adjacent to a first portion of a base, and the sixth loop of the plurality of loops is disposed adjacent to a second portion of the base.

Clause 6. The bag of clause 5, wherein the at least one strap is configured to be coupled to the first loop of the plurality of loops via a fastener of the at least two fasteners and the fifth loop of the plurality of loops via a fastener of the at least two fasteners.

Clause 7. The bag of clause 5, wherein the at least one detachable strap is configured to be coupled to the first loop of the plurality of loops via a fastener of the at least two fasteners and the sixth loop of the plurality of loops via a fastener of the at least two fasteners.

Clause 8. The bag of clause 5, wherein the at least one detachable strap is configured to be coupled to the second loop of the plurality of loops via a fastener of the at least two fasteners and the fifth loop of the plurality of loops via a fastener of the at least two fasteners.

Clause 9. The bag of clause 5, wherein the at least one detachable strap is configured to be coupled to the second loop of the plurality of loops via a fastener of the at least two fasteners and the sixth loop of the plurality of loops via a fastener of the at least two fasteners.

Clause 10. The bag of clause 5, wherein the at least one detachable strap is configured to be coupled to the third loop of the plurality of loops via a fastener of the at least two fasteners and the fifth loop of the plurality of loops via a fastener of the at least two fasteners.

Clause 11. The bag of clause 5, wherein the at least one detachable strap is configured to be coupled to the third loop of the plurality of loops via a fastener of the at least two fasteners and the sixth loop of the plurality of loops via a fastener of the at least two fasteners.

Clause 12. The bag of clause 5, wherein the at least one detachable strap is configured to be coupled to the fourth loop of the plurality of loops via a fastener of the at least two fasteners and the fifth loop of the plurality of loops via a fastener of the at least two fasteners.

Clause 13. The bag of clause 5, wherein the at least one detachable strap is configured to be coupled to the fourth loop of the plurality of loops via a fastener of the at least two fasteners and the sixth loop of the plurality of loops via a fastener of the at least two fasteners.

Clause 14. The bag of any of clauses 6-13, wherein the at least one detachable strap includes a first strap.

Clause 15. The bag of any of clauses 6-13, wherein the at least one detachable strap includes a second strap.

Clause 16. A bag comprising: a base forming a level surface of the bag; a top end opposite the base; and a panel extending from the base to the top end, the panel including: one or more hooks having a first end and a second end; one or more loops disposed adjacent to the top end, the one or more loops are configured to receive either the first end or the second end of at least one of the one or more hooks, thereby coupling the one or more hooks to the panel adjacent to the top end; and one or more straps removably coupled to the other of the first end or the second end of the at least one of the one or more hooks, such that the one or more hooks are configured to couple the one or more straps to the panel adjacent to the top end via the one or more loops.

Clause 17. The bag of clause 16, wherein the one or more loops include a first loop, a second loop, a third loop, a fourth loop, a fifth loop, and a sixth loop.

Clause 18. The bag of clause 17, wherein the first loop and the second loop are disposed on a left side of the panel adjacent to the top end.

Clause 19. The bag of clause 18, wherein the first loop is disposed proximate to a left edge of the left side relative to the second loop.

Clause 20. The bag of clause 19, wherein the third loop and the fourth loop are disposed on a right side of the panel adjacent to the top end.

Clause 21. The bag of clause 20, wherein the third loop is disposed proximate to a right edge of the right side relative to the fourth loop.

Clause 22. The bag of clause 21, wherein the fifth loop is disposed on the left side of the panel adjacent to the base.

Clause 23. The bag of clause 22, wherein the sixth loop is disposed on the right side of the panel adjacent to the base.

Clause 24. The bag of clause 23, wherein the one or more straps extend from the top end at either the first loop or the second loop to the fifth loop.

Clause 25. The bag of clause 23, wherein the one or more straps extend from either the third loop or the fourth loop to the sixth loop.

Clause 26. The bag of clause 23, wherein the one or more straps extend from either the first loop or the second loop to the sixth loop.

Clause 27. The bag of clause 23, wherein the one or more straps extend from either the third loop or the fourth loop to the fifth loop.

Clause 28. The bag of clause 16, wherein the first end of the one or more hooks is reversibly coupled to either of a coupling mechanism or the one or more loops.

Clause 29. The bag of clause 16, wherein at least one of the one or more hooks includes a hook base connecting the first end and the second end.

Clause 30. The bag of clause 16, wherein a combination of the first end, the second end, and the hook base of the one or more hooks form a substantially Z shaped body.

Clause 31. The bag of clause 29, wherein the first end includes a first clip and the second end includes a second clip.

Clause 32. The bag of clause 16, wherein the one or more hooks include at least one hook that has a body that is substantially G-shaped.

Clause 33. A bag comprising: a main compartment having interior surfaces that define an interior volume, the compartment including a first side, a second side, a front side, and a back side; and two shoulder straps releasably coupled to the back side of the main compartment.

Clause 34. The bag of clause 33, wherein each of the two shoulder straps includes a first end and a second end that is opposite of the first end, wherein the first end includes a first loop and the second end includes a second loop.

Clause 35. The bag of clause 34, wherein the back side includes a plurality of loops disposed along a top end of the back side.

Clause 36. The bag of clause 35, wherein the plurality of loops includes a first loop, a second loop, a third loop, and a fourth loop.

Clause 37. The bag of clause 36, wherein the first loop is positioned on an upper left corner of the back side, the second loop is positioned on an upper right corner of the back side, the third loop is disposed on a bottom left corner of the back side, and the fourth loop is disposed on a bottom right corner of the back side.

Clause 38. The bag of clause 37, wherein the first loop is configured to receive a first end of a first hook, the first end of a first strap of the two shoulder straps is configured to receive a second end of the first hook; and wherein the second loop is configured to receive a first end of a second hook, and the first end of a second strap of the two shoulder straps is configured to receive a second end of the second hook.

Clause 39. The bag of clause 38, wherein the third loop is configured to receive a first end of a third hook, the second end of the first strap of the two shoulder straps is configured to receive a second end of the third hook, the fourth loop is configured to receive a first end of a fourth hook, the second end of the second strap of the two shoulder straps is configured to receive a second end of the fourth hook.

Clause 40. The bag of clause 36, wherein the plurality of loops includes a fifth loop and a sixth loop.

Clause 41. The bag of clause 40, wherein the first loop is positioned on an upper corner of the top end of the back side on the first side, the second loop is positioned on an upper corner of the top end of the back side on the second side, the third loop is disposed adjacent to the first loop, the fourth loop is disposed adjacent to the second loop, the fifth loop is disposed on a bottom corner of a bottom end of the bag on the first side, and the sixth loop is disposed on a bottom corner of the bottom end of the bag on the second side.

Clause 42. The bag of clause 41, wherein the first loop is connected via the first hook to the first end of a first strap of the two shoulder straps, and the second loop is connected via the second hook to the first end of a second strap of the two shoulder straps.

Clause 43. The bag of clause 41, wherein the first loop is connected via the first hook to the first end of a first strap of the two shoulder straps, and the third loop is connected via the second hook to the first end of a second strap of the two shoulder straps.

Clause 44. The bag of clause 41, wherein the first loop is connected via the first hook to the first end of a first strap of the two shoulder straps, and the fourth loop is connected via the second hook to the first end of a second strap of the two shoulder straps.

Clause 45. The bag of clause 41, wherein the second loop is connected via the first hook to the first end of a first strap of the two shoulder straps, and the third loop is connected via the second hook to the first end of a second strap of the two shoulder straps.

Clause 46. The bag of clause 41, wherein the second loop is connected via the first hook to the first end of a first strap of the two shoulder straps, and the fourth loop is connected via the second hook to the first end of a second strap of the two shoulder straps.

Clause 47. The bag of clause 41, wherein the third loop is connected via the first hook to the first end of a first strap of the two shoulder straps, and the fourth loop is connected via the second hook to the first end of a second strap of the two shoulder straps.

Clause 48. The bag of any of clauses 42-47, wherein the fifth loop is connected via the third hook to the second end of the first strap of the two shoulder straps, and the sixth loop is connected via the fourth hook to the second end of the second strap of the two shoulder straps.

Clause 49. The bag of clause 39, wherein the first hook and the second hook are a G-hook, the G-hook including an adjustable end and a fixed end; wherein the fixed end is coupled to a portion of a bottom end of the back side, and the adjustable end is attachable to one or more portions of a top end of the back side.

Clause 50. The bag of clause 39, wherein the first hook is a Z-hook and the second hook is a G-hook; wherein the G-hook includes an adjustable end and a fixed end; wherein the fixed end is fixedly attached to a portion of a bottom end of the back side, and the adjustable end is attachable to one or more portions of a top end of the back side; and wherein the Z-hook includes two adjustable ends attachable to a portion of the bottom end of the back side and a portion of the top end of the back side.

Clause 51. The bag of clause 39, wherein each of the first hook and the second hook include a Z-hook; wherein the Z-hook includes two adjustable ends attachable to a portion of a bottom end of the back side and a portion of a top end of the back side.

Clause 52. A bag comprising: a main compartment having interior surfaces that define an interior volume, the main compartment including a first side, a second side, a front side, and a back side surrounding the interior volume; and one or more detachable shoulder straps coupled with the bag.

Clause 53. The bag of clause 52, further comprising: a first panel that is movable away from the main compartment to allow access to the interior volume, the first panel is disposed on the front side; a second panel disposed on the first side; a third panel disposed on the second side; and a fourth panel disposed on the back side.

Clause 54. The bag of clause 53, further comprising: a first zipper track extending from a base of the bag to a top end of the main compartment along the first side and the front side; and a second zipper track extending from the base of the bag to the top end of the main compartment along the second side and the front side; wherein the first zipper track and the second zipper track are noncontiguous with one another; wherein the first zipper track is connects the first panel and the second panel to one another; and wherein the second zipper track is connects the first panel and the third panel to one another.

Clause 55. The bag of clause 53, wherein the fourth panel includes a first set of loops disposed at a top end of the fourth panel, and a second set of loops disposed at a bottom end of the fourth panel.

Clause 56. The bag of clause 55, wherein the fourth panel includes one or more straps, the one or more straps each including a first end having a first loop and a second end having a second loop, each of the first end and the second end are configured to receive a hook including a body that is substantially Z-shaped.

Clause 57. A bag comprising: a main compartment having interior surfaces that define an interior volume, the main compartment including a first side, a second side, a front side, and a back side; and one or more shoulder straps detachably coupled with the bag.

Clause 58. A bag assembly including: a main compartment having interior surfaces that define an interior volume, the main compartment including a first side, a second side, a front side, and a back side, the back side including a plurality of loops; two shoulder straps detachably coupled to the back side of the main compartment, each of the two shoulder straps extend from a first end to a second end opposite the first end, the first end having a first loop and the second end having a second loop; and one or more hooks having a body that is substantially Z-shaped, the one or more hooks having a first arm configured to engage one of the first loop or the second loop, and a second arm configured to engage the other of the first loop or the second loop.

We claim:

1. A bag comprising:
a back panel extending from a bottom end toward a top end, the back panel including:
a plurality of loops disposed along the top end and the bottom end;
at least one detachable strap;
at least two fasteners, each of the at least two fasteners being attachable to the at least one detachable strap, wherein each fastener is able to be detachably coupled to the back panel via at least one of the plurality of loops.

2. The bag of claim 1, wherein the plurality of loops includes six loops;
wherein a first loop of the plurality of loops is positioned at a first side of the back panel on the top end, a second loop of the plurality of loops is positioned at the first side of the back panel on the top end adjacent to the first loop of the plurality of loops, a third loop of the plurality of loops is positioned at a second side of the back panel on the top end, a fourth loop of the plurality of loops is positioned at the second side of the back panel on the top end adjacent to the third loop, a fifth loop of the plurality of loops is positioned at the first side of the back panel at the bottom end, and a sixth loop of the plurality of loops is positioned at the second side of the back panel at the bottom end.

3. The bag of claim 2, wherein the first loop of the plurality of loops is disposed adjacent to an outermost edge of the first side of the back panel, and the fourth loop of the plurality of loops is disposed adjacent to an outermost edge of the second side of the back panel.

4. The bag of claim 3, wherein the second loop of the plurality of loops is disposed adjacent to the first loop of the plurality of loops, and the third loop of the plurality of loops is disposed adjacent to the fourth loop of the plurality of loops.

5. The bag of claim 4, wherein the fifth loop of the plurality of loops is disposed adjacent to a first portion of a base, and the sixth loop of the plurality of loops is disposed adjacent to a second portion of the base.

6. The bag of claim 5, wherein the at least one strap is configured to be coupled to the first loop of the plurality of loops via a fastener of the at least two fasteners and the fifth loop of the plurality of loops via a fastener of the at least two fasteners.

7. The bag of claim 5, wherein the at least one detachable strap is configured to be coupled to the first loop of the plurality of loops via a fastener of the at least two fasteners and the sixth loop of the plurality of loops via a fastener of the at least two fasteners.

8. The bag of claim 5, wherein the at least one detachable strap is configured to be coupled to the second loop of the plurality of loops via a fastener of the at least two fasteners and the fifth loop of the plurality of loops via a fastener of the at least two fasteners.

9. The bag of claim 5, wherein the at least one detachable strap is configured to be coupled to the second loop of the plurality of loops via a fastener of the at least two fasteners and the sixth loop of the plurality of loops via a fastener of the at least two fasteners.

10. The bag of claim 5, wherein the at least one detachable strap is configured to be coupled to the third loop of the plurality of loops via a fastener of the at least two fasteners and the fifth loop of the plurality of loops via a fastener of the at least two fasteners.

11. The bag of claim 5, wherein the at least one detachable strap is configured to be coupled to the third loop of the plurality of loops via a fastener of the at least two fasteners and the sixth loop of the plurality of loops via a fastener of the at least two fasteners.

12. The bag of claim 5, wherein the at least one detachable strap is configured to be coupled to the fourth loop of the plurality of loops via a fastener of the at least two fasteners and the fifth loop of the plurality of loops via a fastener of the at least two fasteners.

13. The bag of claim 5, wherein the at least one detachable strap is configured to be coupled to the fourth loop of the plurality of loops via a fastener of the at least two fasteners and the sixth loop of the plurality of loops via a fastener of the at least two fasteners.

14. The bag of claim 6, wherein the at least one detachable strap includes a first strap.

15. The bag of claim 6, wherein the at least one detachable strap includes a second strap.

16. A bag comprising:
a base forming a level surface of the bag;
a top end opposite the base; and
a panel extending from the base to the top end, the panel including:
one or more hooks having a first end and a second end;
one or more loops disposed adjacent to the top end, the one or more loops are configured to receive either the first end or the second end of at least one of the one or more hooks, thereby coupling the one or more hooks to the panel adjacent to the top end; and
one or more straps removably coupled to the other of the first end or the second end of the at least one of the one or more hooks, such that the one or more hooks are configured to couple the one or more straps to the panel adjacent to the top end via the one or more loops.

17. The bag of claim 16, wherein the one or more loops include a first loop, a second loop, a third loop, a fourth loop, a fifth loop, and a sixth loop, the first loop and the second loop are disposed on a left side of the panel adjacent to the top end, wherein the first loop is disposed proximate to a left edge of the left side relative to the second loop, and wherein the fifth loop is disposed on the left side of the panel adjacent to the base.

18. The bag of claim 17, wherein the one or more straps extend from the top end at either the first loop or the second loop to the fifth loop.

19. A bag comprising:
a main compartment having interior surfaces that define an interior volume, the compartment including a first side, a second side, a front side, and a back side; and
two shoulder straps releasably coupled to the back side of the main compartment.

20. The bag of claim 19, wherein each of the two shoulder straps includes a first end and a second end that is opposite of the first end, wherein the first end includes a first loop and the second end includes a second loop.
